(19) United States
(12) Patent Application Publication
(10) Pub. No.: US 2009/0045974 A1
(43) Pub. Date: Feb. 19, 2009

(54) Short Hop Wireless Telemetry for Completion Systems

(75) Inventor: Dinesh R. Patel, Sugar Land, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/189,345

(22) Filed: Aug. 11, 2008

Related U.S. Application Data
(60) Provisional application No. 60/955,691, filed on Aug. 14, 2007.

(51) Int. Cl. G01V 3/00

(52) U.S. Cl. 340/854.6

(57) ABSTRACT

A downhole wireless communication method and system is provided for a completed wellbore having a mother bore and two or more lateral branches, wherein at least one of the lateral branches is not electrically or hydraulically wet connected to the mother bore. The system includes an upper two-way, short hop, wireless telemetry module disposed within the mother bore and connected to a first power source, and two or more lower two-way, short hop, wireless telemetry modules disposed within the completed wellbore and connected to a second power source wherein at least one of the lower two-way, short hop wireless telemetry modules is disposed within each of the lateral branches. At least one sensor is adapted to measure downhole parameters and at least one flow control valve are communicably coupled to the upper two-way, short hop, wireless telemetry module or the lower two-way, short hop, wireless telemetry modules.

### PRIORITY CLAIM AND CROSS-REFERENCE TO RELATED APPLICATIONS

This patent application is a non-provisional application of U.S. provisional patent application 60/955,691 filed on Aug. 14, 2007 and entitled “Short Hop Wireless Telemetry for Completion System” which is hereby incorporated by reference in its entirety.

### FIELD OF THE INVENTION

The present invention relates generally to an apparatus and method having an integrated well construction and completion system for a well and a multilateral well having multiple lateral branches.

### BACKGROUND OF THE INVENTION

Maximum and extreme reservoir contact wells are drilled and completed for maximizing total hydrocarbon recovery. These wells are long and horizontal, and may have several multilateral branches. Sensors and flow control valves are used for measurement and flow control to optimize recovery from the wells.

Flow control valves and sensors are run in the mother bore for reservoir monitoring and flow control from the mother bore as well from the multilateral branches. Typically an electrical cable or hydraulic control line is run from the surface to supply power and provide communication to sensors and a flow control valve. Sometimes more than one set of sensors and flow control valves are run in the mother bore in a reservoir having multiple zones. However, only one flow control valve and sensor set is run per branch in the mother bore. Running multiple flow control valves and sensors in the mother bore and establishing electrical and hydraulic wet connect between mother bore and lateral branch is not done due to complexity and concern for poor reliability.

As a result, there is a need for an integrated well construction, drilling and completion system to maximize total hydrocarbon recovery.

### SUMMARY OF THE INVENTION

In general, the present invention provides an integrated well construction, drilling and completion system to maximize total hydrocarbon recovery. The completion system provides wireless communication between an upper completion and valves and sensors in the lower completion or the mother bore and valves in the lateral branches. An autonomous power supply is provided in each branch to power the sensors and flow control valves since there is no physical connection between mother bore and lateral branch.

More specifically, one embodiment of the present invention provides a downhole wireless communication system for a completed wellbore having a mother bore and at least one lateral branch, wherein at least one of the lateral branches is not electrically or hydraulically wet connected to the mother bore. The system includes an upper two-way, short hop, wireless telemetry module disposed within the mother bore and connected to a first power source, and two or more lower two-way, short hop, wireless telemetry modules disposed within the completed wellbore and connected to a second power source wherein at is least one of the lower two-way, short hop wireless telemetry modules is disposed within each of the lateral branches. The system also includes at least one sensor adapted to measure downhole parameters and communicably coupled to the upper two-way, short hop, wireless telemetry module or the lower two-way, short hop, wireless telemetry modules, and at least one flow control valve communicably coupled to the upper wireless telemetry module or the lower telemetry module.

Another embodiment of the present invention provides a downhole wireless communication system for a completed wellbore having a mother bore or first segment of the well and at least one lateral branch or second segment, wherein at least one of the lateral branches or second segments is not electrically or hydraulically wet connected to the mother bore or first segments. The system includes an upper two-way, short hop, wireless telemetry module disposed within the mother bore and connected to a battery, a fuel cell, a downhole power generator or a power communication line connected to an external power source, and two or more lower two-way, short hop, wireless telemetry modules disposed within the completed wellbore and connected to a battery, a fuel cell or a downhole power generator wherein at least one of the lower two-way, short hop wireless telemetry modules is disposed within each of the lateral branches. The system also includes at least one sensor adapted to measure downhole parameters and at least one flow control valve communicably coupled to the upper two-way, short hop, wireless telemetry module or the lower two-way, short hop, wireless telemetry modules. The sensor may include a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. The upper and lower two-way, short hop, wireless telemetry modules communicate with one another to relay sensor data or commands up and down the completed wellbore, and the sensor data is analyzed to determine one or more commands to enhance hydrocarbon recovery from the wellbore using the one or more control valves. The upper wireless telemetry module and the lower wireless telemetry module(s) each include a processor communicably coupled to an acoustic or electromagnetic transceiver, and a memory storage unit communicably coupled to the processor.

Yet another embodiment of the present invention provides a method for optimizing hydrocarbon recovery from a completed wellbore having a mother bore and two or more lateral branches, wherein at least one of the lateral branches is not electrically or hydraulically wet connected to the mother bore. Sensor data is received at a lower two-way, short hop, wireless telemetry module disposed within one of the lateral branches. The sensor data is transmitted wirelessly to a controller external to the wellbore via an upper two-way, short hop, wireless telemetry module disposed within the mother bore. The received sensor data is analyzed and one or more commands are determined to enhance hydrocarbon recovery from the wellbore. The command(s) are transmitted to the lower two-way, short hop, wireless telemetry module via the upper two-way, short hop, wireless telemetry module, and then transmitted to one or more control valves communicably connected to the lower two-way, short hop, wireless telemetry module.

Other or alternative features will become apparent from the following description, from the drawings, and from the claims.

### BRIEF DESCRIPTION OF THE DRAWINGS

The above and further advantages of the invention may be better understood by referring to the following description in conjunction with the accompanying drawings, in which:

FIG. 1 illustrates a short hop wireless telemetry system between an upper completion or the first segment of the well and lower completion or a second segment of the well in accordance with one embodiment of the present invention;

FIGS. 2A and 2B illustrate spring loaded pads and wedged pads to establish a physical connection between a liner and a tubing within a wellbore in accordance with one embodiment of the present invention;

FIG. 3 illustrates a short hop wireless telemetry system in a multilateral junction having a physical connection in accordance with another embodiment of the present invention;

FIG. 4 illustrates a electromagnetic short hop wireless telemetry system in a multilateral junction having no physical connection between the mother bore or a first segment of the well and the lateral branch or a second segment of the well in accordance with another embodiment of the present invention;

FIG. 5 illustrates an acoustic short hop wireless telemetry system in a multilateral junction wherein the lateral liner is connected to the main bore casing in accordance with another embodiment of the present invention;

FIG. 6 illustrates an electromagnetic short hop wireless telemetry system in a multilateral junction wherein the lateral liner is connected to the main bore casing in accordance with another embodiment of the present invention;

FIG. 7 illustrates an electromagnetic short hop wireless telemetry system in a multilateral junction wherein the lateral branch is connected to the main bore with a rapid connect in accordance with another embodiment of the present invention;

FIG. 8 illustrates an electromagnetic short hop wireless dedicated telemetry system with two multilateral junctions having no physical connection between the mother bore and each of the first and second segments of the well in accordance with another embodiment of the present invention;

FIG. 9 illustrates an electromagnetic short hop wireless single telemetry system with two multilateral junctions having no physical connection between the mother bore and each of the first and second segments of the well in accordance with another embodiment of the present invention; and

FIG. 10 illustrates a method for short hop wireless telemetry system between an upper and lower completion in accordance with another embodiment of the present invention.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments are possible.

In the description, the terms “connect”, “connection”, “connected”, “in connection with”, and “connecting” are used to mean “in direct connection with” or “in connection with via another element”. The term “set” is used to mean “one element” or “more than one element”. The terms “up” and “down”, “upper” and “lower”, “upwardly” and “downwardly”, “upstream” and “downstream”, “above” and “below”, and other like terms indicating relative positions above or below a given point or element are used in this description to more clearly describe some embodiments of the invention. However, when applied to equipment and methods for use in wells that are deviated or horizontal, such terms may refer to a left to right, right to left, or other relationship as appropriate.

In general, the present invention provides an integrated well construction, drilling and completion system to maximize total hydrocarbon recovery. The completion system provides wireless communication between two segments of the well having no electrical or hydraulic wet connect physical link between the two segments. For example, the wireless communication may be between the upper and lower completions or between the mother bore and various valves located in the lateral branches. An autonomous power supply is provided in each branch or lower completion to power the sensors and flow control valves since there is no physical connection between mother bore and lateral branch or between the upper and lower completions.

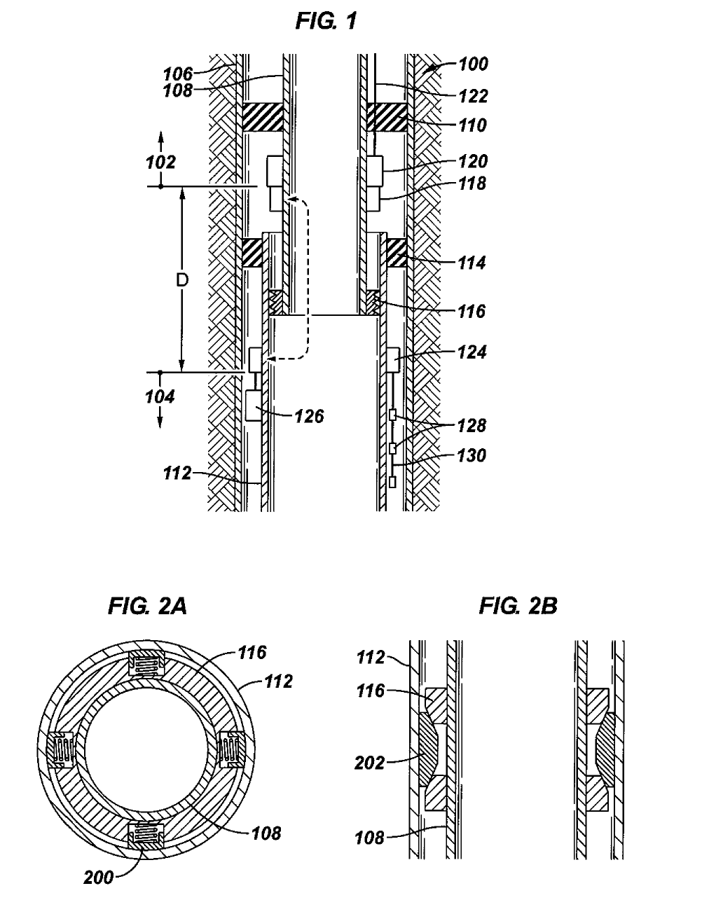

Now referring to FIG. 1, short hop wireless telemetry system 100 between an upper completion or first segment of the well and a lower completion or second segment of the well in accordance with one embodiment of the present invention is shown. A section of a completed wellbore between an upper completion level 102 and a lower completion level 104 includes a casing 106. A tubing 108 is held within the casing 106 using production packer 110. Note that the terms “tubing” and “pipe” are used interchangeably, and refer to any structure defining an inner longitudinal flow conduit. Similarly, a liner 112 is held within the casing 106 using a liner hanger such as a gravel pack packer 114. In addition, a metallic interface 116, such as spring loaded pads (FIG. 2A) or wedged metal pads (FIG. 2B), is used to provided metal to metal contact between the tubing 108 and the liner 112.

As shown, an upper two-way, short hop, wireless telemetry module 118 is attached to the tubing 108 in the upper completion level 102 below the production packer 110. The upper two-way, short hop, wireless telemetry module 118 is also connected to Wellnet station 120, a downhole electronics module for data and command processing (provided by Schlumberger) and a first power source. The first power source can be a battery, a fuel cell, a downhole power generator or a power communication line 122 connected to an external power source. The communication line provides power and communication between the Wellnet station and the surface. The lower two-way, short hop, wireless telemetry module 124 is attached to the liner 112 in the lower completion level 104. The distance D between the upper two-way, short hop, wireless telemetry module 118 and the lower two-way, short hop, wireless telemetry module 124 is preferably within the capability range of short hope wireless telemetry modules (e.g., in some embodiments this may be less than or equal to 400 feet). The lower two-way, short hop, wireless telemetry module is electrically connected to a second power source 126 and communicably coupled to one or more sensors 128 (typically with cable 130) adapted to measure downhole parameters and/or one or more flow control valves. The second power source 126 can be a battery, a fuel cell or a downhole power generator.

The upper wireless telemetry module 118 and/or the lower wireless telemetry module 124 may include a processor communicably coupled to a transceiver. The transceiver can be an acoustic transceiver, an electromagnetic transceiver or other wireless transceiver. Acoustic communication refers to using encoded acoustic waves transmitted through a wellbore. Electromagnetic communication refers to using encoded electromagnetic waves transmitted through the wellbore. A memory storage unit can also be communicably coupled to the processor. The sensor 128 can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. Moreover, the sensors 128 and control valves can be integrated into a single module. In addition, one or more downhole devices can be communicably coupled to the upper wireless telemetry module 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

Referring now to FIGS. 2A and 2B, two different types of metallic interfaces are shown. As shown in FIG. 2A, metallic interface 116 uses spring loaded pads 200 to establish a physical connection between a liner 112 and tubing 108 within a wellbore. The spring loaded pads 200 are typically 2 inches wide and 6 inches long with up to eight pads (only four are shown in this illustrative example). The outside diameter is contoured to match the interior diameter of the liner 112. As shown in FIG. 2B, metallic interface 116 uses wedged pads 202 (up to eight) to establish a physical connection between the liner 112 and the tubing 108 within a wellbore.

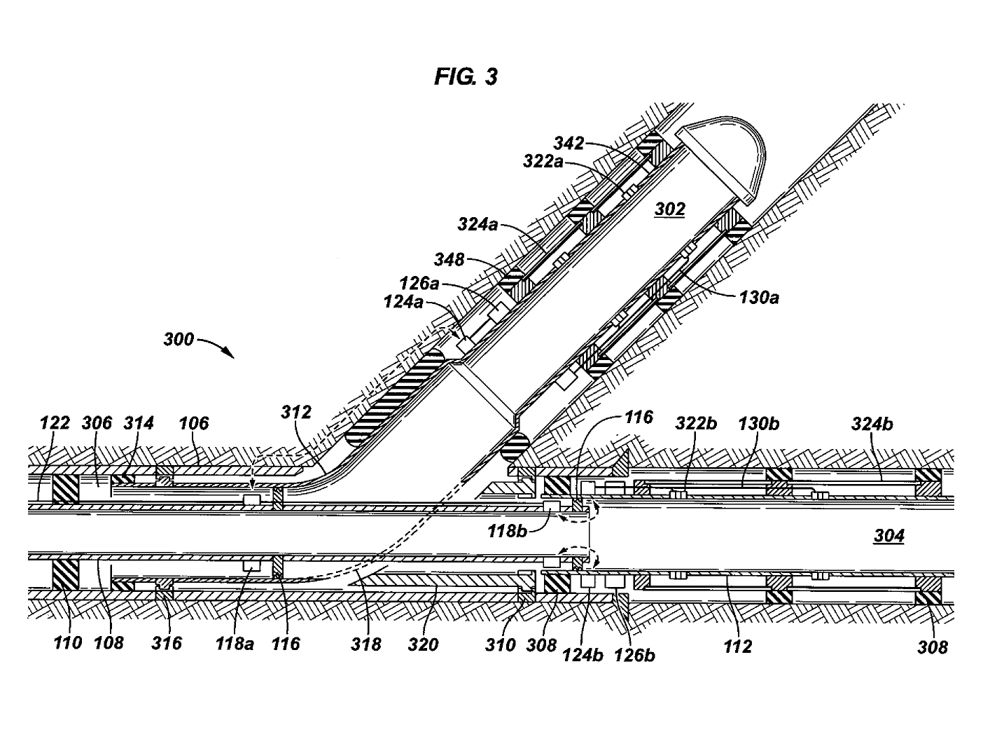

Now referring to FIG. 3, short hop wireless telemetry system 300 in a multilateral junction having a physical connection in accordance with another embodiment of the present invention is shown. The multilateral junction connects a lateral branch 302 and a lower completion section 304 with a main bore 306. A tubing 108 within the main bore 306 is held within the casing 106 using production packer 110 and indexing casing coupling 310. Similarly, a liner 112 within the lower completion section 304 is held within the open wellbore using open hole packers 308. In addition, metallic interfaces 116, such as spring loaded pads (FIG. 2A) or wedged metal pads (FIG. 2B) among others, are used to couple or provided metal to metal contact between the tubing 108 and the junction liner 312 leading to the lateral branch 302, and the tubing 108 and the liner 112 in the lower completion section 304. The junction liner 312 is held within the casing 106 using packer 314 and indexing casing coupling 316. The lateral branch liner 342 is held within the open lateral wellbore using open hole packers 348. The junction liner 312 also includes a pre-milled window 318 and deflector 320 at the interface with the lower completion level 304.

As shown, a first upper two-way, short hop, wireless telemetry module 118a is attached to the tubing 108 in the main bore 306 below the production packer 110 and above the junction. A second upper two-way, short hop, wireless telemetry module 118b is attached to the tubing 108 just before the lower metallic interface 116 coupling the tubing 108 to the lower completion 304. The first and second upper two-way, short hop, wireless telemetry modules 118a,b are also connected to a first power source. The first power source can be a battery, a fuel cell, a downhole power generator or a power communication line 122 connected to an external power source. A first lower two-way, short hop, wireless telemetry module 124a is attached to the liner 312 in the lateral branch 302. The lower two-way, short hop, wireless telemetry module 124a is electrically connected to a second power source 126a and communicably coupled to one or more sensors adapted to measure downhole parameters and/or one or more flow control valves 322a (typically with cable 130a). The flow control valves 322a control the flow from the formation through screens 324a into the lateral branch 302. The second power source 126a can be a battery, a fuel cell or a downhole power generator. A second lower two-way, short hop, wireless telemetry module 124b is attached to the junction liner 112 in the lower completion 304. The lower two-way, short hop, wireless telemetry module 124b is electrically connected to a second power source 126b and communicably coupled to one or more sensors adapted to measure downhole parameters and/or one or more flow control valves 322b (typically with cable 130b). The flow control valves 322b control the flow from the formation through screens 324b into the lower completion 304. The second power source 126b can be a battery, a fuel cell or a downhole power generator.

The upper wireless telemetry module 118 and/or the lower wireless telemetry modules (124a and 124b) may include a processor communicably coupled to a transceiver. The transceiver can be an acoustic transceiver, an electromagnetic transceiver or other wireless transceiver. Acoustic communication refers to using encoded acoustic waves transmitted through a wellbore. Electromagnetic communication refers to using encoded electromagnetic waves transmitted through the wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. Moreover, the sensors and control valves (322a and 322b) can be integrated into a single module. In addition, one or more downhole devices can be communicably coupled to the upper wireless telemetry module(s) 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118a, 118b, 124a and 124b) communicate with one another to relay sensor data or commands up and down the completed wellbore. The sensor data can be analyzed to determine one or more commands to enhance hydrocarbon recovery from the wellbore using the one or more control valves or downhole devices.

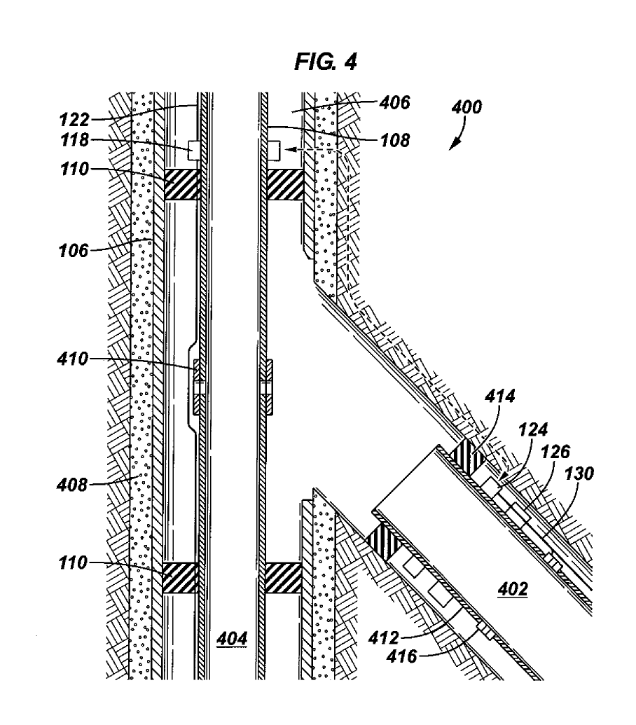

Referring now to FIG. 4, short hop wireless telemetry system 400 in a multilateral junction having no physical connection between the mother bore 406 and the lateral branch 402 in accordance with another embodiment of the present invention is shown. The multilateral junction connects a lateral branch 402 and a lower completion section 404 with a main bore 406. A tubing 108 within the mother bore 406 is held within the casing 106 using production packers 110. In this example, the casing 106 is sealed with cement 408 and the tubing 108 extends below the junction into the lower completion section 404. A sliding sleeve or a flow control valve 410 is attached to the tubing 108 at the junction. The lateral branch liner 412 within the lateral branch 402 is not physically connected to the casing 106 or tubing 108. The lateral branch liner 412 is held in place within the lateral open hole with packer 414.

As shown, an upper two-way, short hop, wireless telemetry module 118 is attached to the tubing 108 in the mother bore 406 above the production packer 110, which is above the junction. The upper two-way, short hop, wireless telemetry module 118 is also connected to a first power source. The first power source can be a battery, a fuel cell, a downhole power generator or a power communication line 122 connected to an external power source. A lower two-way, short hop, wireless telemetry module 124 is attached to the lateral branch is liner 412 in the lateral branch 402. The lower two-way, short hop, wireless telemetry module 124 is electrically connected to a second power source 126 and communicably coupled to one or more integrated flow control valves and sensors 416 (typically with cable 130). The flow control valves 416 control the flow from the formation into the lateral branch 402. The second power source 126 can be a battery, a fuel cell or a downhole power generator.

The upper wireless telemetry module 118 and/or the lower wireless telemetry modules 124 may include a processor communicably coupled to a transceiver. The transceiver is an electromagnetic transceiver or other wireless transceiver that does not require physical contact. Electromagnetic communication refers to using encoded electromagnetic waves transmitted through the wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. In addition, one or more downhole devices can be communicably coupled to the upper wireless telemetry module 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

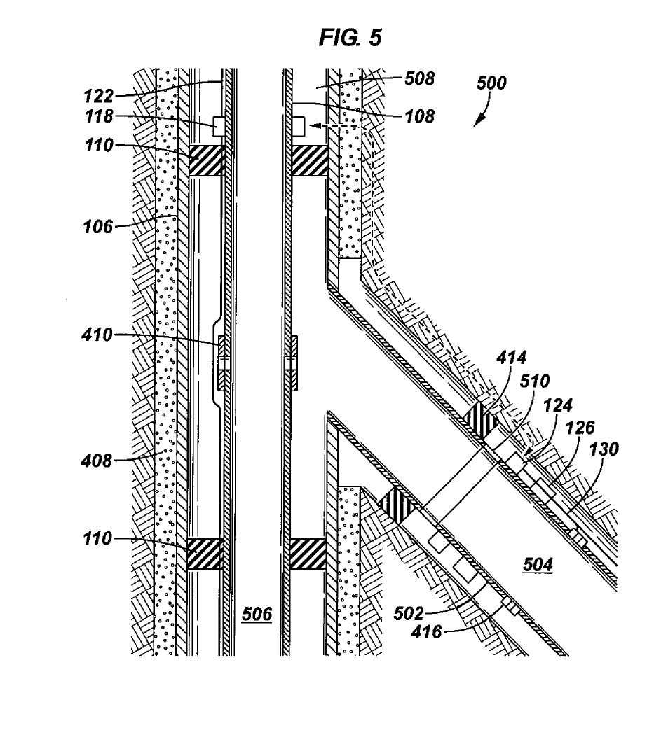

Now referring to FIG. 5, acoustic short hop wireless telemetry system 500 in a multilateral junction wherein the lateral liner 502 is connected to the main bore casing 106 in accordance with another embodiment of the present invention is shown. The multilateral junction connects a lateral branch 504 and a lower completion section 506 with a main bore 508. A tubing 108 within the mother bore 508 is held within the casing 106 using production packers 110. In this example, the casing 106 is sealed with cement 408 and the tubing 108 extends below the junction into the lower completion section 506. A sliding sleeve 410 is attached to the tubing 108 at the junction. The lateral branch liner 502 within the lateral branch 504 is physically connected to the casing 106. The lateral branch liner 502 is held in place within the lateral open hole with packer 414.

As shown, an upper two-way, short hop, wireless telemetry module 118 is attached to the tubing 108 in the mother bore 506 above the production packer 110, which is above the junction. The upper two-way, short hop, wireless telemetry module 118 is also connected to a first power source. The first power source can be a battery, a fuel cell, a downhole power generator or a power communication line 122 connected to an external power source. A lower two-way, short hop, wireless telemetry module 124 is attached to the lateral branch liner 502 in the lateral branch 504. The lower two-way, short hop, wireless telemetry module 124 is electrically connected to a second power source 126 and communicably coupled to one or more integrated flow control valves and sensors 416 (typically with cable 130). The flow control valves 416 control the flow from the formation into the lateral branch 504. The second power source 126 can be a battery, a fuel cell or a downhole power generator.

The upper wireless telemetry module 118 and/or the lower wireless telemetry modules 124 may include a processor communicably coupled to a transceiver. The transceiver is an acoustic transceiver or other wireless transceiver that requires physical contact. Acoustic communication refers to using encoded acoustic waves transmitted through a wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. In addition, one or more downhole devices can be communicably coupled to the upper wireless telemetry module 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

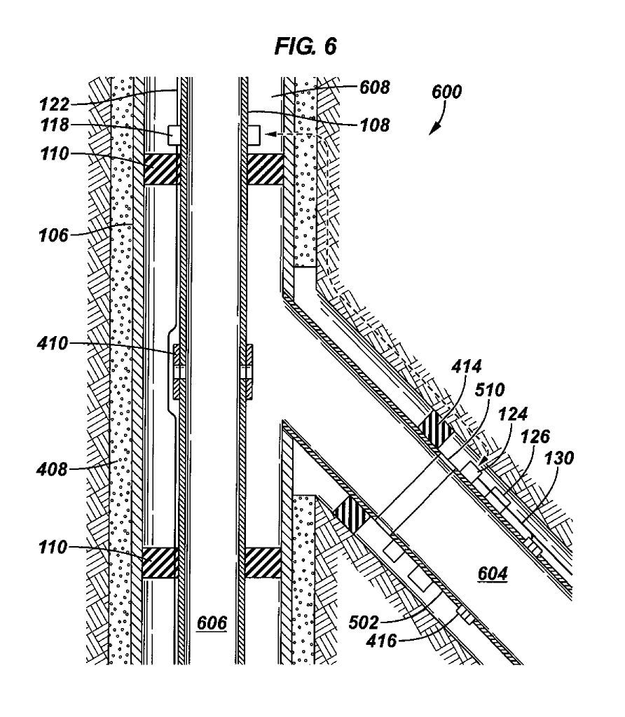

Referring now to FIG. 6, electromagnetic short hop wireless telemetry system 600 in a multilateral junction wherein the lateral liner 502 is connected to the main bore casing 106 in accordance with another embodiment of the present invention is shown. The multilateral junction connects a lateral branch 604 and a lower completion section 606 with a main bore 608. A tubing 108 within the mother bore 608 is held within the casing 106 using production packers 110. In this example, the casing 106 is sealed with cement 408 and the tubing 108 extends below the junction into the lower completion section 606. A sliding sleeve 410 is attached to the tubing 108 at the junction. The lateral branch liner 502 within the lateral branch 604 is physically connected to the casing 106. The lateral branch liner 502 is held in place within the lateral open hole with packer 414.

As shown, an upper two-way, short hop, wireless telemetry module 118 is attached to the tubing 108 in the mother bore 606 above the production packer 110, which is above the junction. The upper two-way, short hop, wireless telemetry module 118 is also connected to a first power source. The first power source can be a battery, a fuel cell, a downhole power generator or a power communication line 122 connected to an external power source. A lower two-way, short hop, wireless telemetry module 124 is attached to the lateral branch liner 502 in the lateral branch 604. The lower two-way, short hop, wireless telemetry module 124 is electrically connected to a second power source 126 and communicably coupled to one or more integrated flow control valves and sensors 416 (typically with cable 130). The flow control valves 416 control the flow from the formation into the lateral branch 504. The second power source 126 can be a battery, a fuel cell or a downhole power generator. An insulated gap 510 is positioned between the lower two-way, short hop, wireless telemetry module 124 and the packer 414.

The upper wireless telemetry module 118 and/or the lower wireless telemetry modules 124 may include a processor communicably coupled to a transceiver. The transceiver is an electromagnetic transceiver or other wireless transceiver that does not require physical contact. Electromagnetic communication refers to using encoded electromagnetic waves transmitted through the wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. In addition, one or more downhole devices can be communicably coupled to the upper wireless telemetry module 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

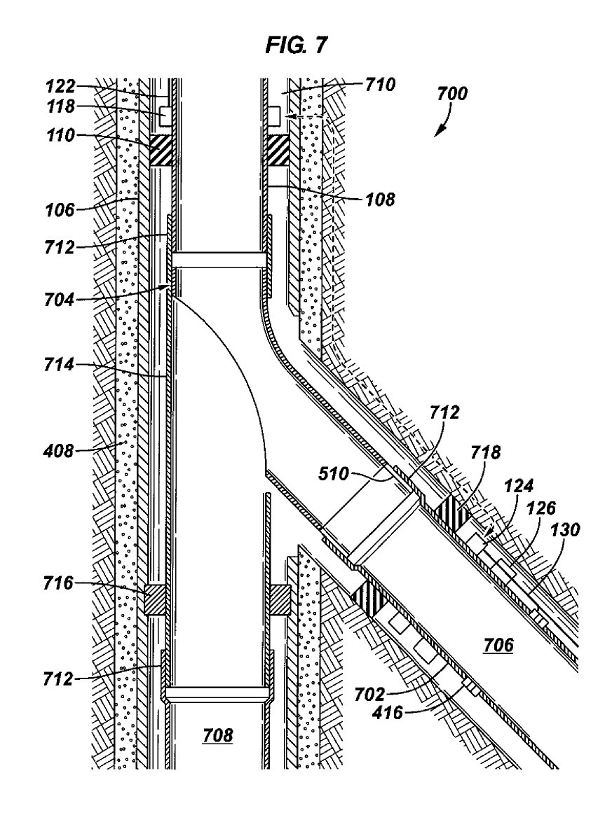

Now referring to FIG. 7, electromagnetic short hop wireless telemetry system 700 in a multilateral junction wherein the lateral branch liner 702 is connected to the main bore casing 106 and tubing 108 with a rapid connector 704 in accordance with another embodiment of the present invention is shown. The multilateral junction connects a lateral branch 706 and a lower completion section 708 with a main bore 710. A tubing 108 within the mother bore 608 is held within the casing 106 using production packers 110. In this example, the casing 106 is sealed with cement 408 and the tubing 108 extends below the junction into the lower completion section 606. In this embodiment, polished bore receptacles 712, templates 714 and selective locators 716 are used in the completion system. The lateral branch liner 702 within the lateral branch 706 is physically connected to the casing 106 and tubing 108. The lateral branch liner 502 is held in place within the lateral open hole with open hole zonal isolation packer 718.

As shown, an upper two-way, short hop, wireless telemetry module 118 is attached to the tubing 108 in the mother bore 710 above the production packer 110, which is above the junction. The upper two-way, short hop, wireless telemetry module 118 is also connected to a first power source. The first power source can be a battery, a fuel cell, a downhole power generator or a power communication line 122 connected to an external power source. A lower two-way, short hop, wireless telemetry module 124 is attached to the lateral branch liner 702 in the lateral branch 706. The lower two-way, short hop, wireless telemetry module 124 is electrically connected to a second power source 126 and communicably coupled to one or more integrated flow control valves and sensors 416 (typically with cable 130). The flow control valves 416 control the flow from the formation into the lateral branch 706. The second power source 126 can be a battery, a fuel cell or a downhole power generator. An insulated gap 510 may be positioned between the lower two-way, short hop, wireless telemetry module 124 and the packer 414.

The upper wireless telemetry module 118 and/or the lower wireless telemetry modules 124 may include a processor communicably coupled to a transceiver. The transceiver is an electromagnetic transceiver or other wireless transceiver that does not require physical contact. Electromagnetic communication refers to using encoded electromagnetic waves transmitted through the wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. In addition, one or more downhole devices can be communicably coupled to the upper wireless telemetry module 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

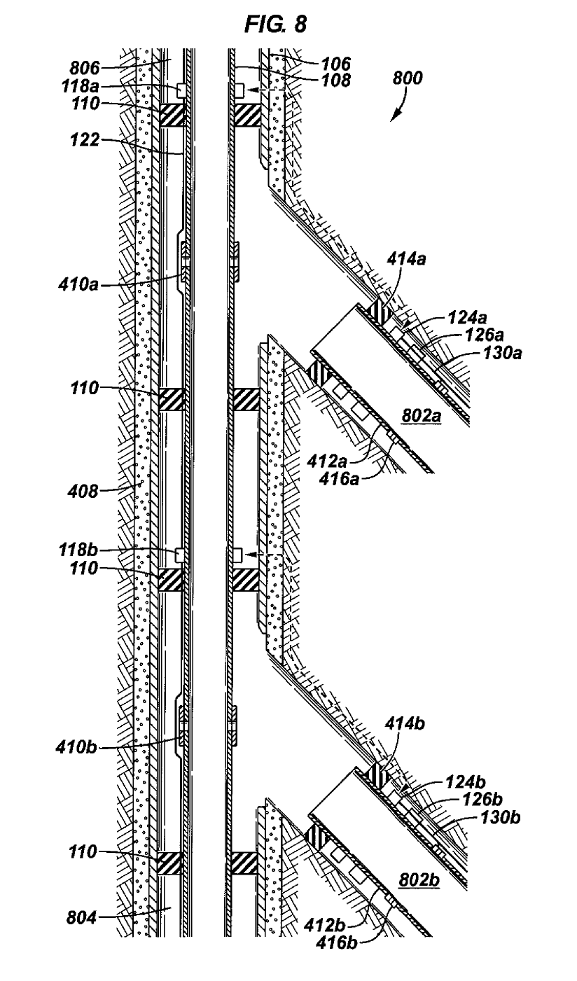

Referring now to FIG. 8, short hop wireless dedicated telemetry system 800 in a well with first and second multilateral junctions having no physical connection between the mother bore 806 and each of the lateral branch(s) 802 in accordance with another embodiment of the present invention is shown. The first multilateral junction connects a first lateral branch 802a with a main bore 806. A tubing 108 within the mother bore 806 is held within the casing 106 using production packers 110. In this example, the casing 106 is sealed with cement 408 and the tubing 108 extends below the junction into a second multilateral branch 802b and a lower completion section 804. A first sliding sleeve or a first flow control valve 410a is attached to the tubing 108 at the first junction. The first lateral branch liner 412a within the first lateral branch 802a is not physically connected to the casing 106 or tubing 108. The first lateral branch liner 412a is held in place within the lateral open hole with packer 414a.

The second multilateral junction connects a second lateral branch 802b with the main bore 806. The tubing 108 extends below the second multilateral branch 802b into the lower completion section 804. A second sliding sleeve or a second flow control valve 410b is attached to the tubing 108 at the second junction. The second lateral branch liner 412b within the second lateral branch 802b is not physically connected to the casing 106 or tubing 108. The second lateral branch liner 412b is held in place within the lateral open hole with packer 414b.

As shown, a first upper two-way, short hop, wireless dedicated telemetry module 118a is attached to the tubing 108 in the mother bore 806 above the production packer 110 located above the first junction. The first upper two-way, short hop, wireless telemetry module 118a is also connected to a first power source. The first power source can be a battery, a fuel cell, a downhole power generator or a power communication line 122 connected to an external power source. A first lower two-way, short hop, wireless telemetry module 124a is attached to the first lateral branch liner 412a in the first lateral branch 802a. The first lower two-way, short hop, wireless telemetry module 124a is electrically connected to a second power source 126a and communicably coupled to one or more integrated flow control valves and sensors 416a (typically with cable 130a). The flow control valves 416a control the flow from the formation into the first lateral branch 802a. The second power source 126a can be a battery, a fuel cell or a downhole power generator.

In addition to the first upper two-way, short hop, wireless dedicated telemetry module 118a, there is also a second upper two-way, short hop, wireless dedicated telemetry module 118b attached to the tubing 108. The second upper two-way, short hop, wireless dedicated telemetry module 118b is located in the mother bore 806 above the production packer 110 located below the first junction and above the second junction. The second upper two-way, short hop, wireless telemetry module 118b may also be connected to a first power source. The first power source can be a battery, a fuel cell, a downhole power generator or a power communication line 122 connected to an external power source. The first power source for the second upper two-way, short hop, wireless telemetry module 118b may be the same as the power source for first upper two-way, short hop, wireless telemetry module 118a or there may be separate first power sources for each of the upper telemetry module(s) 118.

A second lower two-way, short hop, wireless telemetry module 124b is attached to the second lateral branch liner 412b in the second lateral branch 802b. The second lower two-way, short hop, wireless telemetry module 124b is electrically connected to a second power source 126b and communicably coupled to one or more integrated flow control valves and sensors 416b (typically with cable 130b). The flow control valves 416b control the flow from the formation into the second lateral branch 802b. The second power source 126b can be a battery, a fuel cell or a downhole power generator.

The upper wireless telemetry modules 118 and/or the lower wireless telemetry modules 124 may include a processor communicably coupled to a transceiver. The transceiver is an electromagnetic transceiver or other wireless transceiver that does not require physical contact. Electromagnetic communication refers to using encoded electromagnetic waves transmitted through the wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. In addition, one or more downhole devices can be communicably coupled to the upper wireless telemetry module(s) 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

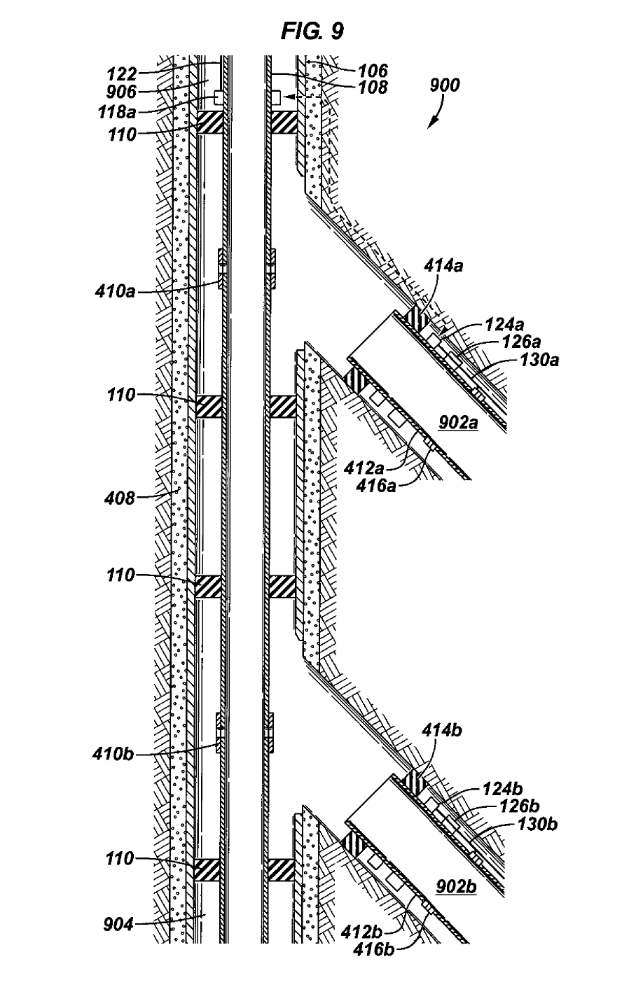

Referring now to FIG. 9, short hop wireless single telemetry system 900 in a well with first and second multilateral junctions having no physical connection between the mother bore 906 and each of the lateral branch(s) 902 in accordance with another embodiment of the present invention is shown. The first multilateral junction connects a first lateral branch 902a with a main bore 906. A tubing 108 within the mother bore 906 is held within the casing 106 using production packers 110. In this example, the casing 106 is sealed with cement 408 and the tubing 108 extends below the junction into another multilateral branch 902b and the lower completion section 904. A first sliding sleeve or a first flow control valve 410a is attached to the tubing 108 at the first junction. The first lateral branch liner 412a within the first lateral branch 902a is not physically connected to the casing 106 or tubing 108. The first lateral branch liner 412a is held in place within the lateral open hole with packer 414a.

The second multilateral junction connects a second lateral branch 902b with the main bore 906. The tubing 108 extends below the second multilateral junction into the lower completion section 904. A second sliding sleeve or a second flow control valve 410b is attached to the tubing 108 at the second junction. The second lateral branch liner 412b within the second lateral branch 902b is not physically connected to the casing 106 or tubing 108. The second lateral branch liner 412b is held in place within the lateral open hole with packer 414b.

As shown, a single upper two-way, short hop, wireless dedicated telemetry module 118 is attached to the tubing 108 in the mother bore 906 above the production packer 110 located above the first junction. The upper two-way, short hop, wireless telemetry module 118 is also connected to a first power source. The first power source can be a battery, a fuel cell, a downhole power generator or a power communication line 122 connected to an external power source. A first lower two-way, short hop, wireless telemetry module 124a is attached to the first lateral branch liner 412a in the first lateral branch 902a. The first lower two-way, short hop, wireless telemetry module 124a is electrically connected to a second power source 126a and communicably coupled to one or more integrated flow control valves and sensors 416a (typically with cable 130a). The flow control valves 416a control the flow from the formation into the first lateral branch 902a. The second power source 126a can be a battery, a fuel cell or a downhole power generator.

A second lower two-way, short hop, wireless telemetry module 124b is attached to the second lateral branch liner 412b in the second lateral branch 902b. The second lower two-way, short hop, wireless telemetry module 124b is electrically connected to a second power source 126b and communicably coupled to one or more integrated flow control valves and sensors 416b (typically with cable 130b). The flow control valves 416b control the flow from the formation into the second lateral branch 902b. The second power source 126b can be a battery, a fuel cell or a downhole power generator.

The upper wireless telemetry module 118 and/or the lower wireless telemetry modules 124 may include a processor communicably coupled to a transceiver. The transceiver is an electromagnetic transceiver or other wireless transceiver that does not require physical contact. Electromagnetic communication refers to using encoded electromagnetic waves transmitted through the wellbore. A memory storage unit can also be communicably coupled to the processor. The sensor can be a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof. In addition, one or more downhole devices can be communicably coupled to the upper wireless telemetry module(s) 118 or the lower wireless telemetry module(s) 124. The downhole devices can be sampling devices, a device used in intelligent or smart well completion, actuators, locks, release mechanisms, data recorders, resistivity array devices, acoustic devices, downhole memory units, downhole controllers, perforating devices, shape charges, firing heads, locators or downhole tools. The upper and lower two-way, short hop, wireless telemetry modules (118 and 124) communicate with one another to relay sensor data or commands up and down the completed wellbore. The sensor data can be analyzed to determine one or more commands to enhance hydrocarbon recovery from the wellbore using the one or more control valves or downhole devices.

Note that FIGS. 1 and 3-9 can be combined or modified to provide short hop wireless telemetry in completion systems having any number or types of completion level/zones and/or multilateral branches/levels/zones. The completion systems are only shown for multilateral level 2 and 3. However, the same concept could be used for other levels.

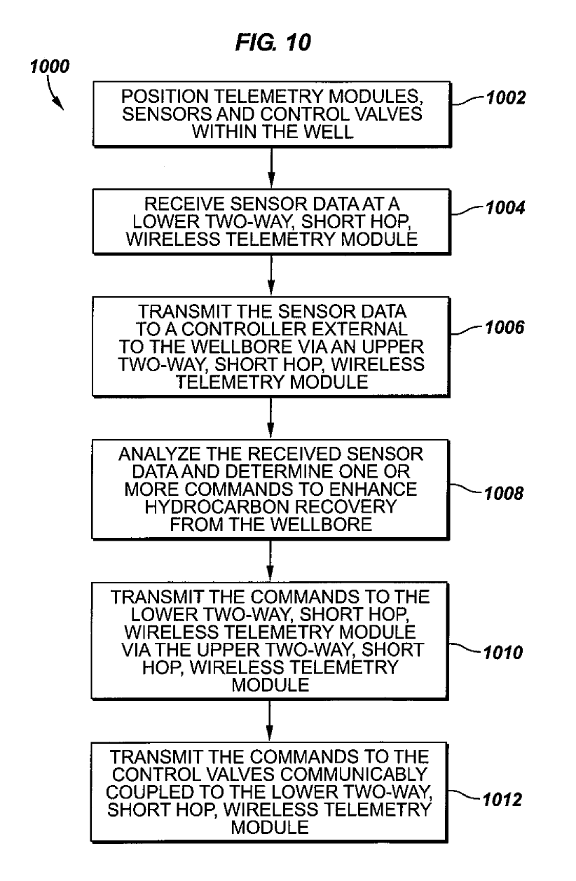

Referring now to FIG. 10, a method 1000 for short hop wireless telemetry system between an upper and lower completion in accordance with another embodiment of the present invention is shown. The telemetry modules, sensors and control valves are positioned within the well in block 1002. Sensor data is received at a lower two-way, short hop, wireless telemetry module disposed within one of the lateral branches in block 1004. The sensor data is transmitted wirelessly to a controller external to the wellbore via an upper two-way, short hop, wireless telemetry module disposed within the mother bore in block 1006. The received sensor data is analyzed and one or more commands are determined to enhance hydrocarbon recovery from the wellbore in block 1008. The command(s) are transmitted to the lower two-way, short hop, wireless telemetry module via the upper two-way, short hop, wireless telemetry module in block 1010, and then transmitted to one or more control valves communicably connected to the lower two-way, short hop, wireless telemetry module in block 1012. Note that the sensor data and the command(s) can be further transmitted via one or more intermediate two-way, short hop, wireless telemetry modules disposed between the upper two-way, short hop, wireless telemetry module and the lower two-way, short hop, wireless telemetry modules.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A downhole wireless communication system for a well having at least two segments wherein the communication between said segments is wireless, comprising:
a first wireless telemetry module disposed within a first segment of the well and communicably coupled and powered from a surface via a cable;
at least one second wireless telemetry module disposed within at least one segment of the well having one or more second segments and coupled to at least one downhole power source and at least one downhole device; and
wherein the first wireless telemetry module is wirelessly communicably coupled with the at least one second wireless telemetry module.

2. The system of claim 1, wherein the at least one downhole device is a sensor configured to measure a downhole parameter and is communicably coupled to at least the second wireless telemetry module.

3. The system of claim 1, wherein the at least one downhole device is a flow control valve configured to be communicably coupled to at least the second wireless telemetry module.

4. The system of claim 1, wherein the at least one downhole device is coupled to the second telemetry module via a cable.

5. The system of claim 1, wherein the wireless telemetry between the first and the at least one of the second segments is electromagnetic.

6. The downhole wireless communication system of claim 1, wherein the wireless telemetry between the first and the at least one of the second segments is acoustic where there is at least some direct metal to metal connection or contact between the first and the at least one second segments.

7. The system of claim 1, wherein the first wireless telemetry module communicates with two or more second wireless telemetry modules within at least one second segment.

8. The system of claim 1, wherein each of the two or more second wireless telemetry modules communicates with a corresponding first wireless telemetry module.

9. The system of claim 1, further comprising a mechanical interface device configured to establish a metal to metal connection between the first segment and the at least one of the second segments.

10. The system of claim 9, wherein the mechanical interface device comprises one or more biased collars or wedged pads configured to provided a metal to metal connection between a tubing and a liner.

11. A downhole wireless communication system for a completed wellbore having a mother bore and one or more lateral branches, wherein at least one of the lateral branches is not electrically or hydraulically wet connected to the mother bore, comprising:
an upper wireless telemetry module disposed within the mother bore and connected to a first power source;
two or more lower wireless telemetry modules disposed within the completed wellbore wherein at least one of the lower wireless telemetry modules is disposed within each of the lateral branches;
at least one sensor adapted to measure downhole parameters and communicably coupled to the upper wireless telemetry module or the lower wireless telemetry modules;
at least one flow control valve communicably coupled to the upper wireless telemetry module or the lower wireless telemetry module; and
a second power source electrically connected to each of the lower wireless telemetry modules.

12. The system of claim 11, wherein more than one lower wireless telemetry modules is disposed in at least one of the lateral branches.

13. The system of claim 11, wherein each lateral branch comprises two or more levels and at least one wireless telemetry module is disposed in each level.

14. The system of claim 11, wherein the upper and lower wireless telemetry modules communicate with one another to relay sensor data or commands up and down the completed wellbore.

15. The system of claim 11, wherein the upper wireless telemetry module and the lower wireless telemetry module(s) each comprise a processor communicably coupled to a transceiver.

16. The system of claim 15, wherein the transceiver comprises an acoustic transceiver or an electromagnetic transceiver.

17. The system of claim 11, wherein the first power source comprises a battery, a fuel cell, a downhole power generator or a power communication line connected to an external power source.

18. The system of claim 11, wherein the second power source comprises a battery, a fuel cell or a downhole power generator.

19. A method for optimizing hydrocarbon recovery from a completed wellbore having a mother bore and two or more lateral branches, wherein at least one of the lateral branches is not electrically or hydraulically wet connected to the mother bore, the method comprising the steps of:
receiving sensor data at a lower wireless telemetry module disposed within one of the lateral branches;
transmitting the sensor data wirelessly to a controller external to the wellbore via an upper wireless telemetry module disposed within the mother bore;
analyzing the received sensor data and determining one or more commands to enhance hydrocarbon recovery from the wellbore;
transmitting the command(s) to the lower wireless telemetry module via the upper wireless telemetry module; and
transmitting the command(s) to one or more control valves communicably connected to the lower wireless telemetry module.

20. The method of claim 19, wherein the sensor data and the command(s) are further transmitted via one or more intermediate wireless telemetry modules disposed between the upper wireless telemetry module and the lower wireless telemetry modules.

21. The method of claim 19, wherein the upper wireless telemetry module and the lower wireless telemetry module(s) each comprise a processor communicably coupled to an acoustic or electromagnetic transceiver.

22. The method of claim 19, wherein:
the upper wireless telemetry module is electrically connected to a first power source;
the lower wireless telemetry module(s) is electrically connected to a second power source; and
the sensor comprises a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H2S detector or CO2 detector, or a combination thereof.

23. A downhole wireless communication system for a completed wellbore having a mother bore and two or more lateral branches, wherein at least one of the lateral branches is not electrically or hydraulically wet connected to the mother bore, comprising:
an upper two-way, short hop, wireless telemetry module disposed within the mother bore and connected to a battery, a fuel cell, a downhole power generator or a power communication line connected to an external power source;
two or more lower two-way, short hop, wireless telemetry modules disposed within the completed wellbore wherein at least one of the lower two-way, short hop wireless telemetry modules is disposed within each of the lateral branches;
at least one sensor adapted to measure downhole parameters and communicably coupled to the upper wireless telemetry module or the lower wireless telemetry modules, wherein the sensor comprises a gauge, a temperature sensor, a pressure sensor, a flow rate measurement device, an oil/water/gas ratio measurement device, a scale detector, a vibration sensor, a sand detection sensor, a water detection sensor, a viscosity sensor, a density sensor, a bubble point sensor, a composition sensor, a resistivity array sensor, an acoustic sensor, a near infrared sensor, a gamma ray detector, a H₂S detector or CO₂ detector, or a combination thereof;
at least one flow control valve communicably coupled to the upper wireless telemetry module or the lower wireless telemetry module;
a battery, a fuel cell or a downhole power generator electrically connected to each lower wireless telemetry module.
wherein the upper and lower wireless telemetry modules communicate with one another to relay sensor data or commands up and down the completed wellbore, and the sensor data is analyzed to determine one or more commands to enhance hydrocarbon recovery from the wellbore using the one or more control valves; and
wherein the upper wireless telemetry module and the lower wireless telemetry module(s) each comprise a processor communicably coupled to an acoustic or electromagnetic transceiver, and a memory storage unit communicably coupled to the processor.
